(19) United States
(12) Patent Application Publication
(10) Pub. No.: US 2006/0022364 A1
(43) Pub. Date: Feb. 2, 2006

(54) Method for making golf ball cores and apparatus for use therein

(76) Inventors: Stephen K. Scolamiero, Bristol, RI (US); Michael F. Vieira, Acushnet, MA (US); William Brum, Raynham, MA (US)

Correspondence Address: ACUSHNET COMPANY, 333 BRIDGE STREET, P. O. BOX 965, FAIRHAVEN, MA, 02719, US

(21) Appl. No.: 11/237,494

(22) Filed: Sep. 28, 2005

Related U.S. Application Data
(63) Continuation-in-part of application No. 09/973,344, filed on Oct. 9, 2001.

(51) Int. Cl. B29C 43/02

(52) U.S. Cl. 264/40.4; 264/148; 264/320; 425/141; 425/308

(57) ABSTRACT

The present invention relates to method and apparatus for making golf ball cores. The method includes using an inspection system during preform formation to measure the preform. The measurements are used to determine the measured preform volume and compare it to a standard preform volume. The method also includes using mold with pairs of self-aligning half-molds. The apparatus for inspecting the preforms comprises a non-contact measuring device, such as a camera. The self-aligning half-molds each include an upper surface with an angularly offset portion. When the offset portions mate during mold closure, the half-molds move with respect to one another.

### CROSS-REFERENCE TO RELATED APPLICATION

This application is a continuation-in-part of co-pending U.S. application Ser. No. 09/973,344, which was filed Oct. 9, 2001 and is incorporated herein in its entirety by express reference thereto.

### FIELD OF THE INVENTION

The present invention relates to a method for making golf ball cores and apparatus for use therein. More preferably, the present invention relates to a method and apparatus for controlling preforms molded to form golf ball cores and a self-aligning mold for use in making the cores.

### BACKGROUND OF THE INVENTION

Core compositions for solid golf balls comprise primarily of polybutadiene. In such compositions, the polybutadiene is usually mixed with other materials until a uniform composition is obtained. This uniform composition is subsequently feed into an extruder and a die. The extruder generally includes a screw-conveying device that forces the composition through the die. The material exits the die preferably at a predetermined discharge rate as a continuous length or extrudate. The extrudate is then guided past a cutting device, such as a rotating knife. The cutting device has a substantially constant cutting rate so that the extrudate is cut into discrete pieces referred to as preforms.

The actual discharge rate typically varies from the predetermined discharge rate due to a number of factors such as the core composition viscosity, the extruder start-up and shut-down conditions, and the extruder feed techniques. Such variations in the actual discharge rate combined with the substantially constant cutting rate, cause the preforms to have a variety of sizes, which is undesirable.

U.S. Pat. No. 4,065,537 discloses a process for producing molded golf balls where slugs of polybutadiene are formed into single-piece golf balls. Although the patent discloses ideal dimensions for the slugs, it does not disclose measuring the slugs once formed to see if these dimensions are met. So, the slugs produced may or may not meet the desired dimensions.

U.S. Pat. No. 6,258,302 discloses a process for producing polybutadiene golf ball cores. This patent discloses mixing core materials together to form core stock and testing the stock for various physical and rheological properties, such as compression and COR prior to forming the stock into slugs or preforms. The patent further discloses cutting the stock into preforms or slugs of predetermined size and/or weight. The weight or size of the preforms is controlled through volume control that synchronizes the cutting device with the advance of a hydraulic ram that forces the material through a die. The patent, however, does not disclose measuring the slugs once formed to see if the weight or size is correct. As a result, the slugs produced also may or may not meet the desired dimensions.

U.S. Pat. No. 5,024,130 discloses a flyknife cutter for extruded materials but does not disclose using the cutter in golf ball core manufacture. The patent discloses using the cutter with motion control devices such as optical length sensors. Although such sensors measure length, they do not measure other extrudate dimensions that can affect the size of cut pieces. As a result, the cut pieces produced may or may not meet the desired size.

According to one conventional process, an operator periodically checks the size of the preforms. During these checks, the operator removes several preforms from the process, manually checks their weight using a scale, and mentally compares the measured weight against a preset weight standard. The operator then decides if manual adjustment of the knife cutting rate is necessary for the preforms to meet the weight standard. Since the operator does not know if the preforms meet the weight standard until after the manual check is done, there is no advance warning if the preforms are non-conforming. The consequences of using non-conforming preforms for cores are discussed below.

Each preform is advanced to a spherical cavity defined by a pair of half-molds within a compression mold. The compression mold subjects the preform to heat and pressure, which causes the preform to expand and fill the spherical cavity. The preform cures in the mold to form a golf ball core. If the preform used is smaller than the standard, the mold cavity will not be full of material and an incomplete core or a core with voids can be formed. If the preform used is larger than the standard, once the cavity is full the excess preform material exits the cavity into an overflow area. This excess material cures into scrap or “flash.” The scrap is typically ground up and reincorporated into future core material batches or disposed. There is a limit to the amount of scrap that can be incorporated into core material without degrading the properties of the cores, and disposing of scrap adds costs to the making of cores. Thus, it is preferred to minimize the amount of scrap produced. The challenge is to make the preforms of sufficient size to fill the core mold cavities with minimal excess.

Another factor influences scrap formation during core molding. Typically, the half-molds are fixed within mold frames so that they cannot move during molding. Differential thermal effects and mechanical mismatches of the half-molds can cause dimensional errors within the molds. As a result, the half-molds can be misaligned during molding. This allows excess preform material to escape the cavity. This excess material contributes to the undesirable formation of scrap. These errors can also cause the cores to be out-of-round. Out-of-round cores can form unplayable balls.

### SUMMARY OF THE INVENTION

The present invention is directed to a method of making golf ball cores including the steps of providing at least one pair of half-molds to form a spherical cavity, forming at least one preform, measuring each preform, using the measurements to determine a measured volume of each preform, and comparing the measured volume of each preform to a predetermined standard preform volume. The method also includes the steps of advancing each preform to each spherical cavity if the measured volume is substantially equal to the predetermined standard preform volume, and closing each pair of half-molds such that the half-molds move with respect to one another into alignment about each preform.

According to another embodiment of the present invention, the present invention is directed to a method of processing preforms for making golf ball cores. The method includes the steps of: forming at least one preform, measuring each preform, and using the measurements to determine a measured volume of each preform.

During the method, which includes forming preforms, all the preforms or a significant portion of the each preform produced can be measured or inspected. The method can use a machine vision system, camera, laser, ultrasonic or other non-contact device to measure the preforms. The measurements can be compared to a standard volume measurement to determine if the preforms conform or not to the standard. A visual or audible signal can be sent to notify an operator that a preform is non-conforming. In response, the operator can make manual adjustments to the process to make the preforms conform. Alternatively, a signal can be sent to a controller for automatically adjusting the process with or without notifying the operator.

The present invention is also directed to an apparatus for processing preforms for use in making golf ball cores. The apparatus comprises a die, an extruder, a cutting device and a non-contact measuring device. The die shapes a core composition. The extruder forces the core composition through the die to form an extrudate. The cutting device cuts the extrudate into preforms. The non-contact measuring device measures at least two dimensions of each preform to determine a volume of each preform.

The present invention is further directed to a mold for making a golf ball core. The mold comprises an upper frame member, a lower frame member, and at least one pair of upper and lower half-molds. Each frame member has at least one cavity and the pair of upper and lower half-mold is positioned in the respective cavities of the upper and lower frame members. Each half-mold includes a surface portion and is configured and dimensioned to allow the half-molds to move transversely with respect to the upper and lower frame members such that when the surface portions of the upper and lower half-molds contact the upper and lower half-molds move into alignment. The molds and half-molds can also be configured to allow vertical movement of the half-molds during alignment.

### BRIEF DESCRIPTION OF THE DRAWINGS

In the accompanying drawings which form a part of the specification and are to be read in conjunction therewith and in which like reference numerals are used to indicate like parts in the various views:

FIG. 1 is a flow chart illustrating a method of making golf ball cores according to the present invention;

FIG. 2 is a schematic, elevational view of an apparatus for processing core compositions according to the present invention;

FIG. 3 is an elevational view of a sensor panel for use in the processing apparatus of FIG. 2;

FIG. 4 is a partial, cross-sectional view of a compression mold according to the present invention, wherein the mold is in a closed position; and

FIG. 5 is a cross-sectional view of a portion of the compression mold of FIG. 4, wherein the half-molds are in an open position.

### DETAILED DESCRIPTION OF THE INVENTION

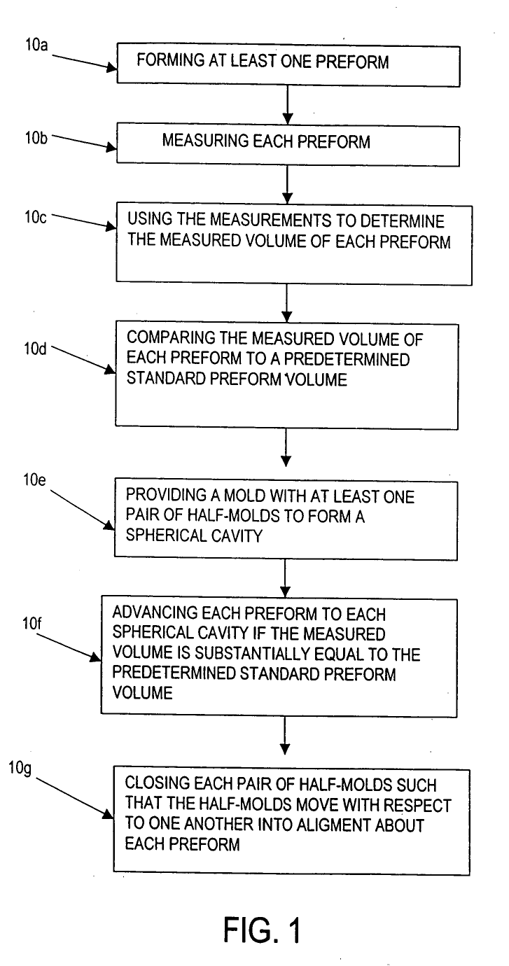

Referring to FIG. 1, the present invention is directed to a method of making golf ball cores. These cores are substantially solid and form a center of a golf ball. To form the balls, the cores of the present invention can surrounded by a single-layer or multiple-layer cover then painted. These balls may also include intermediate layers of molded or wound material as known by those of ordinary skill in the art. The present invention is therefore not limited to incorporating the cores into any particular golf ball construction and the present cores can be used in any constructions.

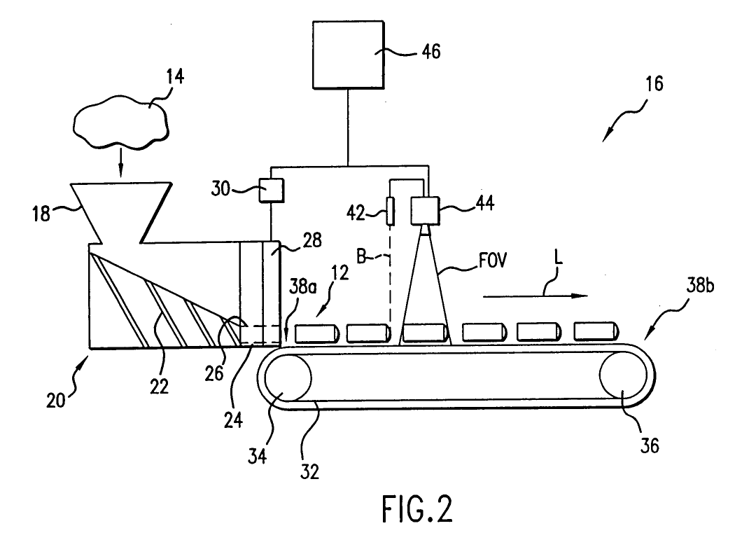

The method includes steps 10a-g as shown in FIG. 1. Step 10a includes forming at least one preform 12, as shown in FIG. 2. This step 10a includes the steps of forming a core composition 14 comprising for example, at least polybutadiene, metal salt diacrylate, dimethacrylate, or monomethacrylate, a free radical initiator, and zinc or calcium oxide.

The polybutadiene preferably has a cis 1,4 content of above about 90% and more preferably above about 96%. Commercial sources of polybutadiene include Shell 1220 manufactured by Shell Chemical, Neocis BR40 manufactured by Enichem Elastomers, and Ubepol BR150 manufactured by Ube Industries, Ltd. If desired, the polybutadiene can also be mixed with other elastomers known in the art, such as natural rubber, styrene butadiene, and/or isoprene in order to further modify the properties of the core. When a mixture of elastomers is used, the amounts of other constituents in the core composition are based on 100 parts by weight of the total elastomer mixture.

The metal salt diacrylates, dimethacrylates, and monomethacrylates suitable for a preferred embodiment include those wherein the metal is magnesium, calcium, zinc, aluminum, sodium, lithium or nickel. Zinc diacrylate is preferred, because it provides golf balls with a high initial velocity. The zinc diacrylate can be of various grades of purity. For the purposes of this specification, a lower quantity of zinc stearate present in the zinc diacrylate produces a zinc diacrylate of higher purity. Zinc diacrylate containing less than about 10% zinc stearate is preferable. More preferable is zinc diacrylate containing about 4-8% zinc stearate. Suitable, commercially available zinc diacrylates include those from Rockland React-Rite and Sartomer. The preferred concentrations of zinc diacrylate that can be used are 20-50 pph based upon 100 pph of polybutadiene or alternately, polybutadiene with a mixture of other elastomers that equal 100 pph can be used.

Free radical initiators are used to promote cross-linking of the metal salt diacrylate, dimethacrylate, or monomethacrylate and the polybutadiene. Suitable free radical initiators for a preferred embodiment include, but are not limited to peroxide compounds, such as dicumyl peroxide, 1,1-di(t-butylperoxy)3,3,5-trimethyl cyclohexane, a-a bis(t-butylperoxy)diisopropylbenzene, 2,5-dimethyl-2,5 di(t-butylperoxy)hexane, or di-t-butyl peroxide, and mixtures thereof. Other useful initiators would be readily apparent to one of ordinary skill in the art without any need for experimentation. The initiator(s) at 100% activity are preferably added in an amount ranging between about 0.05 and 2.5 pph based upon 100 parts of butadiene, or butadiene mixed with one or more other elastomers. More preferably, the amount of initiator added ranges between about 0.15 and 2 pph and most preferably between about 0.25 and 1.5 pph. The free radical initiator is added in an amount dependent upon the amounts and relative ratios of the starting components, as would be well understood by one of ordinary skill in the art.

The core composition can include 5 to 50 pph of zinc oxide in a zinc diacrylate-peroxide cure system that cross-links polybutadiene during the core molding process. Alternatively, the zinc oxide can be eliminated in favor of calcium oxide in the golf ball core composition. The amount of calcium oxide added to the core-forming composition as an activator is typically in the range of about 0.1 to 15, preferably 1 to 10, most preferably 1.25 to 5, parts calcium oxide per hundred parts (pph) of polybutadiene.

The compositions of the present invention may also include fillers, added to the elastomeric composition to adjust the density and/or specific gravity of the core. As used herein, the term “fillers” includes any compound or composition that can be used to vary the density and other properties of the subject golf ball core. Fillers useful in the golf ball core according to the present invention include, for example, zinc oxide (in an amount significantly less than that which would be necessary without the addition of the calcium oxide), barium sulfate, and regrind (which is recycled cured core material ground to 30 mesh particle size). The amount and type of filler utilized is governed by the amount and weight of other ingredients in the composition. Appropriate fillers generally used range in specific gravity from about 2.0 to 5.6.

Antioxidants may also be included in the elastomer cores. Antioxidants are compounds which prevent the breakdown of the elastomer. Useful antioxidants include, but are not limited to, quinoline type antioxidants, amine type antioxidants, and phenolic type antioxidants.

Other ingredients such as accelerators, e.g. tetra methylthiuram, processing aids, processing oils, plasticizers, dyes and pigments, as well as other additives well known to the skilled artisan may also be used in amounts sufficient to achieve the purpose for which they are typically used.

All the ingredients except the free radical initiator (i.e., peroxides) are mixed in a Process Lab Brabender mixer until a set of predetermined conditions is met, i.e., time and temperature of mixing. For example, the ingredients can be mixed until a temperature of between about 82.2° C. (180° F.) to about 93.3° C. (200° F.) is reached. The resulting mixture is removed from the mixer and formed into sheets using a twin mill with a fixed gap or knip to insure a homogeneous or uniform core composition 14, as shown in FIG. 2. The sheets are preferably air cooled to about room temperature and the sheets are then slit into strips with a width of about 2 inches to about 5 inches depending on the core stock.

An apparatus or processing system 16 shown in FIG. 2, includes a hopper 18 for feeding the strips of core composition 14 to an extruder 20. The extruder 20 includes a screw-conveying device 22 therein. The strips of uniform core composition 14 are feed into the hopper 18 manually or automatically. From the hopper 18, the core composition 14 enters the screw-conveying device 22, which forces the composition through a die 24 downstream thereof. In the die 24, the composition passes through a preferably circular bore 26 (shown in phantom) such that the composition exits the die as a continuous cylindrical length or extrudate. Next, the extrudate passes through a cutting device 28 with a predetermined cutting rate such that the extrudate is cut into discrete pieces or preforms 12. The cutting device 28 includes a motor controller 30 for controlling the cutting rate thereof. One recommended extruder is manufactured by Davis-Standard Corporation located in Pawcatuck, Conn.

The processing system 16 further preferably includes a motor driven belt 32 passing over two rollers 34 and 36. The belt 32 includes a first end 38a that receives the preforms 12 as they exit the cutting device 28 and moves them longitudinally along the process line in the direction L or toward a second end 38b. At the second end 38b, preferably an automated device moves the preforms from the belt 32 to a set-up jig for use in loading the preforms into a mold. The automated device and set-up jig are commercially available and known by those of ordinary skill in the art.

Between the cutting device first end 38a and the second end 38b of the belt 32, the system 16 further includes a sensor 42 and a camera 44. The sensor 42 and camera 44 are preferably mounted on a rigid stand or the like that can support them above the belt 32. The camera 44 is preferably located downstream of the sensor 42 and is in communication with the sensor 42. The sensor 42 is an optical proximity sensor. More preferably, the sensor 42 is a light sensor, such as a laser beam, that emits a light beam B. The present invention, however, is not limited to using such sensors.

When the preform 12 breaks the light beam B, the sensor 42 sends a signal to the camera 44 to capture at least one image of the preform 12. The sensor 42 and camera 44 are set up so that when the preform 12 breaks the beam B, the camera shutter opens and an image of the preform in its field-of-view (FOV) is taken. The camera 44 preferably includes an image analyzer used to take and analyze images as discussed below. The sensor 42 and camera 44 are preferably connected to the cutting device motor controller 30 and a computer 46. The computer 46 includes a microprocessor and preferably but optionally a monitor. The computer 46 preferably includes a logic controller for controlling the motor controller 30. The camera 44 measures two or more dimensions of the preforms.

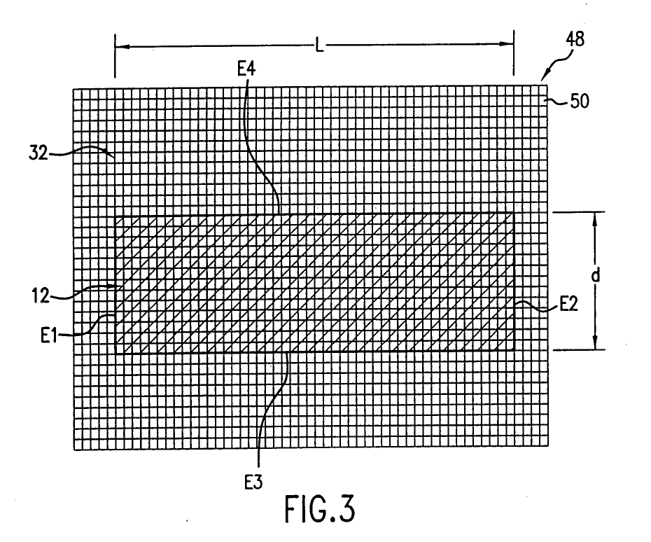

As shown in FIG. 3, the camera 44 includes a sensor panel 48 with a grid of light sensitive sensors or pixels 50. When the shutter of the camera 44 opens, the sensor panel 48 is exposed to light reflected off of the scene taken and the reflected light forms a light pattern on the panel 48. Since the camera 44 is located above the belt 32, the FOV is established to capture the belt 32 and the preform 12. On the panel 48, the belt 32 surrounds the preform 12, which is shown with a cross-hatching pattern, to represent the color contrast between these areas on the sensor panel 48. Multiple cameras may be used for looking at different angles to capture multiple projected images and then obtaining an average volume.

Referring again to FIG. 1, the method further includes the step 10b of measuring each preform. This measuring is done by the camera 44 (as shown in FIG. 2) taking a two-dimensional image of the preform 12 and belt 32. The image is represented on the sensor panel 48 shown in FIG. 3. The camera is set up to differentiate between the preform 12 and the belt 32. Using the blob analysis mode and edge tools, an operator can select a contrast value from multiple shades of gray that ranges between full black and full white so that the processor can define edges E1-E4 of preform 12. This allows the analysis to account for partially-filled pixels. The size of the preform 12 is measured by the camera image analyzer or processor in relation to the full size of the sensor panel 48. The continuous expanse of pixels along a straight line between edges E1 and E2 of the preform can be considered a length L in the unit of pixels. The continuous expanse of pixels along a straight line between defined edges E3 and E4 of the preform can be considered a diameter of the cylindrical-shaped preform in the unit of pixels. As a result, at least two dimensions of the preform 12 are measured. In actual use, the camera 44 is capable of taking multiple measurements of the preform 12 and averaging these measurements to achieve an accurate measurement.

Turning again to FIG. 1, the step 10c includes using the measurements of length and diameter to determine a relative measured volume V_{M} of each preform 12. The measured volume V_{M} is calculated using the following formula:
V_{M}=L×(D/2)²×π

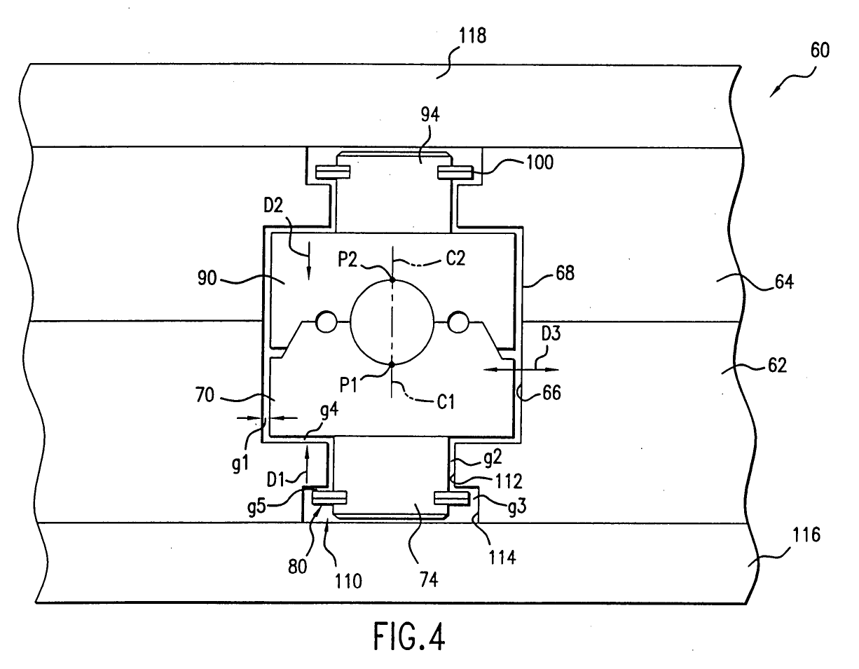

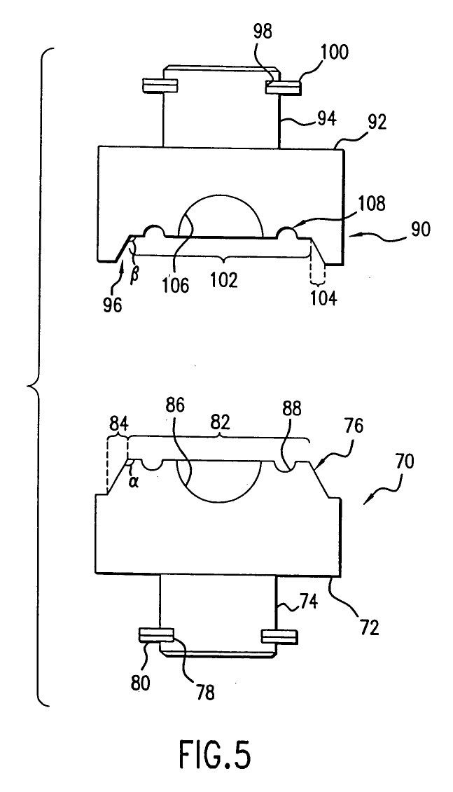

In step 10d, the measured volume V_{M} is compared to a predetermined standard preform volume V_{S} stored in the image analyzer or computer 46. The standard preform volume is preferably determined by machining a replica of the ideal preform and measuring this preform using the camera 44. The comparison is done by the image analyzer or by the external computer 46. In step 10e, a mold 60, as shown in FIGS. 4 and 5, is provided with at least one pair of half-molds 90 and 70 to from a spherical cavity. The mold 60 is discussed in detail below. Subsequently thereto, in step 10f if the measured volume V_{M} is substantially equal to the standard preform volume V_{S} (i.e., within about 5% of the standard preform volume V_{S}) the preform is conforming and is advanced to the end 38b of belt 32 and later to the mold 60. If the measured volume V_{M} is substantially unequal to the standard preform volume V_{S}, more specifically if the measured volume V_{M} is less than the standard preform volume V_{S} by about 5% or greater than the standard preform volume V_{S} by about 5%, the preform is non-conforming. More preferably, if the measured volume V_{M} is conforming if the measured volume V_{M} is within about 1% to about 2% of the standard preform volume V_{S}, and non-conforming if the difference between the volumes is outside of this range.

When a non-conforming preform is identified, a signal is preferably sent to a device for providing a visual cue to the operator such as illuminating a light. Alternatively or additionally, when a non-conforming preform is identified, a signal can be sent to a device for providing an audible cue to the operator such as sounding an alarm. The visual and audible cues can be provided by the computer, which typically includes a monitor, a sound card, and speakers. Alternatively, the visual and audible cues can be provided by other devices separate from the computer. Alternatively or additionally, when a non-conforming preform is identified, a signal can be sent to an automated device for loading the set-up jig to direct the preform away from the set-up jig and to, for example, a reject bin. As a result, the non-conforming preform is moved away from the mold. Alternatively, these non-cured, non-conforming preforms can be easily recycled back into the core composition, or discarded.

The software of the automated device can be modified to perform the removal function. Alternatively, other devices can be used to direct the preform away from the mold. For example, a blast of air can be used to remove the preform or a mechanical device, such as a mechanical arm can be used to remove the preform.

Preferably and additionally, when a non-conforming preform is identified, a signal can be sent to the motor controller 30 for the cutting device 28 (shown in FIG. 2) to modify the cutting rate. Changing the cutting rate changes the length L (as shown in FIG. 3) of the preform 12 and thus changes the preform volume. The cutting rate can be adjusted (i.e., increased or decreased) until the measured volume V_{M} is substantially equal to the predetermined standard preform volume V_{S}. As a result, the process is controlled or automatically corrected. Alternatively, the operator upon receiving the visual or audible cue can manually control or correct the cutting rate to produce conforming preforms.

Sensor 42 for triggering the camera 44 is commercially available. A camera with image analyzer capable of performing either of the above measured volume calculations is commercially available and manufactured by Cognex.

Referring to FIGS. 4 and 5, the preferred mold 60 for use with the method of the present invention will now be discussed. The mold 60 includes a lower frame member 62 and an upper frame member 64. Each of the frame members 62 and 64 define at least one cavity 66 and 68, respectively therein. It will be appreciated that preferably there are a number of cavities in each frame member 62 and 64 with only one thereof being shown in each in FIG. 4.

The cavity 66 in the lower frame member 62 receives a lower half-mold 70. The lower half-mold 70 includes an exterior surface 72 (best seen in FIG. 5) with an extension 74 extending outwardly therefrom and an opposite interior surface 76. The extension 74 further includes a circumferentially extending groove 78 for receiving a retaining ring 80 therein. The retaining ring 80 is formed separately from the extension 74. In another embodiment, a projection can be formed integrally with the extension 74 to function as the retaining ring.

The interior surface 76 includes a first portion 82 and a second portion 84. The first portion 82 includes a central-truncated-spherical cavity 86 and an overflow groove 88 spaced from and circumscribing the truncated spherical cavity 86. The cavity 86 includes a central axis C1 extending through a pole P1 of the cavity. The second portion 84 circumscribes and is angularly offset from the first portion 82 by an angle α. Preferably, the angle α is between about 105° and about 145° and more preferably the angle α is about 120°.

The cavity 68 in the upper frame member 64 receives an upper half-mold 90. The upper half-mold 90 includes an exterior surface 92 with an extension 94 extending outwardly therefrom and an opposite interior surface 96. The extension 94 further includes a circumferentially extending groove 98 for receiving a retaining ring 100 therein. The retaining ring is formed separately from the extension 94. In another embodiment, a projection can be formed integrally with the extension 94 to function as the retaining ring.

The interior surface 96 includes a first portion 102 and a second portion 104. The first portion 102 includes a central-truncated-spherical cavity 106 and an overflow groove 108 spaced from and circumscribing the truncated spherical cavity 106. The cavity 106 includes a central axis C2 extending through a pole P2 of the cavity. The second portion 104 circumscribes and is angularly offset from the first portion 102 by an angle β. Preferably, the angle β is between about 105° and about 145° and more preferably the angle β is about 120°. It will be appreciated that preferably there are a number of pairs of half-molds 70 and 90 in each frame member 62 and 64 with only one thereof being shown in each in FIG. 4.

The cavity 86 is a truncated sphere of preferably greater than hemispherical dimension and the cavity 106 is a truncated sphere of preferably less than hemispherical dimension as disclosed in U.S. Pat. No. 4,389,365 incorporated by reference herein in its entirety. This configuration and dimension of the cavity allow cores to be retained in the lower half-mold 70 after molding. The present invention, however, is not limited to half-mold with cavities configured as disclosed above. For example, the dimensions of the truncated-spherical cavities of each half-mold can be reversed or the cavities can be hemispherical.

Preferably, the half-molds 70 and 90 are formed as a single piece including the extensions 74 and 94 and cavities 86 and 106 by machined casting. The grooves 88 and 108, respectively are optional and preferably machined into the half-molds. The second portions 84 and 104 of the upper surface of each half-mold are machined with a precise mating angle within about 0.5%. One preferred material for forming the half-molds is hardened steel with chrome plating. Alternatively, the half-molds can be formed of beryllium, copper or aluminum but are not limited to these materials. The retaining rings are preferably formed of commercially available materials such as carbon or stainless steel. If integral projections are used to retain the half-molds, these projections can be machined.

The present invention can also be incorporated into compression molds as disclosed in U.S. Pat. No. 5,795,529 incorporated by reference herein in its entirety, which can be used to form various elements of a golf ball such as its cover. Such molds are used in casting processes as disclosed in U.S. Pat. No. 5,733,428 incorporated by reference herein in its entirety.

Referring again to FIG. 4, the lower and upper mold plates 62, 64 each include a stepped bore 110. The bore 110 includes a narrow portion 112 and an enlarged portion 114. Each narrow portion 112 receives the extensions 74 and 94 of each half-mold 70 and 90, respectively. Each enlarged portion 114 receives the retainer rings 80 and 100 of each half-mold 70 and 90, respectively. The retainer rings and the configuration of the bore 110 and cavities 66 and 68 allow the half-molds 70 and 90 to move vertically in the directions D1 and D2 and the opposites thereof. Preferably, less than about 0.030 inches of vertical movement is allowable and more preferably less than about 0.020 inches of vertical movement is allowable. Alternatively, the mold can be formed so that vertical movement of the half-molds is prevented.

The half-molds 70 and 90 and the cavities 66 and 68 respectively are configured and dimensioned such that a gap g1 is formed therebetween. The extensions 74 and 94 and the narrow portion 112 of each bore 110 are configured and dimensioned such that a gap g2 is formed therebetween. The retainer rings 80 and 100 and the enlarged portion 114 of each bore 110 and cavities 66 and 68 are configured and dimensioned such that gaps g3, g4, and g5 are formed.

The mold 60 further includes a lower back-up plate 116 adjacent the lower mold plate 62 and an upper back-up plate 118 adjacent the upper mold plate 64. The lower and upper back-up plates 116 and 118 are optional. The mold plates 62 and 64 and back-up plates 116 and 118 are preferably formed of steel.

In another embodiment, the mold can be configured to include an ejection apparatus for assisting in removing the cores after molding as disclosed in the '365 patent. Conventional alignment aids, such as dowels and associated bores at the corners of the frame members 62 and 64, can be used to align the frame members 62 and 64 with respect to one another.

Referring to FIGS. 1 and 4, in step 10e the method of the present invention includes providing a mold 60 with at least one pair of half-molds 70 and 90 to form a spherical cavity. In step 10f, recall that preferably conforming preforms 12 (as shown in FIG. 2) are advanced to the spherical cavity and disposed in the cavity 86 of the lower half-mold 70. Then, the half-molds are advanced toward one another in the directions D1 and D2 or closed using a conventional compression molding press. The dowels and bores of the frame member 62 and 64 align the frame members with respect to one another. When the second portions 84 and 104 (as best seen in FIG. 5) of the half-molds 70 and 90, respectively, contact each other, the gaps g1, g2 and g3 allow the half-molds 70 and 90 to move substantially transversely with respect to one another in the directions illustrated by the arrow D3 into alignment. As compared to the closing directions D1 and D2 the half-molds 70, 90 move along direction D3 angularly offset from the closing directions. More preferably, half-molds 70, 90 move substantially horizontally with respect to one another in the directions illustrated by the arrow D3 into alignment. Thus, during closing the half-molds 70 and 90 align such that the central axis C1 and the central axis C2 are coaxial. When the second portions 84 and 104 (as best seen in FIG. 5) of the half-molds 70 and 90, respectively, contact each other, the gaps g4 and g5 allow the half-molds 70 and 90 to move vertically with respect to one another in the directions illustrated by the arrows D1 and D2 or in directions opposite thereto.

Once the mold 60 is completely closed, compression molding occurs at a predetermined time, temperature, and pressure to crosslink the preform material. For example, compression molding can occur at about 160° C. (320° F.) for about 15 minutes at a cavity pressure of 3000 psi to form the cores. After compression molding, the cores can remain in the molds until the material is completely or partially cured.

While various descriptions of the present invention are described above, it is understood that the various features of the present invention can be used singly or in combination thereof. For example, the method and apparatus above can be used in molding other rubber or plastic compounds. The inspection and measuring method and apparatus can be used with or without the mold 60, and vice versa. Therefore, this invention is not to be limited to the specifically preferred embodiments depicted therein.

We claim:

1. A method of making golf ball cores including the steps of:
feeding a material through a die having a circular shaped bore to form an extrudate;
cutting the extrudate to form at least one preform;
moving on a conveyor belt the at least one preform into a field of view;
measuring in the field of view the length and diameter of each preform to obtain a measured volume therein;
comparing the measured volume of each preform to a predetermined standard preform volume;
advancing each preform into a spherical cavity of a mold frame upon the measured volume being substantially equal to the predetermined standard preform volume; and
molding each preform into a golf ball core.

2. The method of claim 1, wherein the step of extruding further includes continuously extruding the material.

3. The method of claim 1, wherein the step of cutting includes controlling the cutting rate by use of a motor controller to control the speed of a cutting device.

4. The method of claim 1, wherein the step of measuring each preform further includes providing at least one light sensor that emits a light beam which when broken by the preform transposing on the conveyor belt sends a signal to at least one camera to capture at least one image of at least two-dimensions for each preform.

5. The method of claim 4, wherein the at least one camera includes an image analyzer for measuring each preform based upon data of the image on a sensor panel wherein the measured volume is determined by the number of pixels along the length and diameter of the preform image.

6. The method of claim 5, further including providing a visual cue if the measured volume is substantially unequal to the predetermined standard preform volume.

7. The method of claim 5, further including providing an audible cue if the measured volume is substantially unequal to the predetermined standard preform volume.

8. The method of claim 1, further including directing each preform away from the mold if the measured volume is substantially unequal to the predetermined standard preform volume.

9. The method of claim 8, wherein the preform is directed away from the mold if the measured volume is about 2% more or less than the standard preform volume.

10. The method of claim 1, further including modifying a rate of cutting if the measured volume is substantially unequal to the predetermined standard preform volume until the measured volume is substantially equal to the predetermined standard preform volume.

11. The method of claim 10, wherein the step of modifying the rate of cutting is automatic.

12. An apparatus for processing preforms for use in making golf ball cores comprising:
a die for shaping a generally cylindrically shaped core composition;
an extruder for forcing the core composition through the die to form an extrudate;
a cutting device for cutting the extrudate into preforms;
a non-contact measuring device for measuring at least two dimensions of each preform to determine a volume of each preform;
a belt conveyor for transporting the preforms to a mold for forming the cores.

13. The apparatus of claim 12, wherein the non-contact measuring device includes at least one camera.

14. The apparatus of claim 13, further including a sensor for triggering the camera to take at least one two dimensional image of each preform.

15. The apparatus of claim 14, further including a motor controller for controlling the cutting device and the motor controller receiving signals from the camera related to the volume of each preform.

16. The apparatus of claim 12, wherein the mold comprises:
an upper frame member and a lower frame member, each frame member having at least one cavity; and
at least one pair of upper and lower half-molds positioned in the cavities or the upper and lower frame members respectively, each half-mold having a surface portion,
wherein the cavities and half-molds are configured and dimensioned to allow the half-molds to move transversely with respect to the upper and lower frame members such that when the surface portions of the upper and lower half-molds make contact with each other, the upper and lower half-molds move into alignment.

17. The apparatus of claim 16, wherein the edges of the half-molds include a first portion and a second portion angularly offset from the first portion.

18. The apparatus of claim 17, wherein the second portion is angularly offset from the first portion by about 105° to about 145°.
